(19) United States
(12) Patent Application Publication
(10) Pub. No.: US 2005/0191468 A1
(43) Pub. Date: Sep. 1, 2005

(54) Contoured laminated slate and method for production thereof

(76) Inventor: Neil Sater, Solvang, CA (US)

Correspondence Address: FELIX L. FISCHER, ATTORNEY AT LAW, 1607 MISSION DRIVE, SUITE 204, SOLVANG, CA, 93463, US

(21) Appl. No.: 10/788,760

(22) Filed: Feb. 27, 2004

(51) Int. Cl. B32B 3/14

(52) U.S. Cl. 428/174

(57) ABSTRACT

A contoured laminated slate incorporates a slate veneer backed by a cured resin. The resin is poured onto a slate sheet within a form and partially cured. A slate veneer is cleaved from the slate sheet and the slate veneer with resin attached is pressed on a shaped mold and the resin is fully cured. The resulting product provides a lightweight slate laminate having the curved contour of the mold.

### BACKGROUND OF THE INVENTION

1. Field of the Invention

This invention relates generally to the field of laminated slate products and, more particularly, to a process for creating a light weight contoured laminated slate element for use in architectural and artistic products.

2. Description of the Related Art

Slate is a well know material for architectural and artistic uses. The myriad of colors and textures of slate available provide aesthetically pleasing appearance as tiles and in sheet product for inlays, wall panels and other accessories. Slate has become particularly popular as an element of fountains due to the laminar flow effects of water over a slate surface and the enhancement of colors created by wetting the slate.

Examples of fountains employing slate in vertical wall mounted units or self-standing fountains are produced by Water Wonders, Inc. of Santa Maria, Calif. Such fountains may be small table top units or complete walls of shimmering water effects.

The use of slate in such products is hampered by the weight of slate sheets required to achieve sufficient structural strength in the slate and the limitation to planar applications due to the rigidity of the slate.

It is therefore desirable to provide a laminated slate product that is lighter weight than raw slate sheet while retaining the necessary structural strength to avoid cracking of the slate.

Additionally, it is desirable for a laminated slate product to be formable to allow production of contoured slate products for increased aesthetic appearance and practical application.

### SUMMARY OF THE INVENTION

The present invention comprises a contoured laminated slate having a slate veneer backed by a cured resin. The contoured laminated slate is produced by cutting a sheet of slate to a desired dimension then placing a form around the edges of the slate sheet. Resilient dams are inserted intermediate the slate sheet and the form and a resin layer is poured over the slate sheet to form a laminated slate precursor. The resin is allowed to partially cure and the resilient dams and form are removed. A slate veneer which is adhered to the resin is cleaved from the slate sheet and placed onto a contoured mold. The laminated slate precursor is pressed to the mold surface and the resin is allowed to completely cure. The contoured laminated slate is then removed from the mold.

### BRIEF DESCRIPTION OF THE DRAWINGS

These and other features and advantages of the present invention will be better understood by reference to the following detailed description when considered in connection with the accompanying drawings wherein:

FIG. 1 is a perspective view of a preparatory form for the slate laminating process of the present invention;

FIG. 2 is a perspective view of the form of FIG. 1 with removable foam inserts employed as resin dams in place around the slate sheet;

FIG. 3 is a partial section view of the form of FIG. 2 with the laminated slate precursor in place.

FIG. 4 is a perspective view of a first embodiment of a contour mold having a lateral wave pattern to receive the laminated slate precursor;

FIG. 5 is a perspective view of a second embodiment of a contour mold having a longitudinal arc to receive the laminated slate precursor; and,

FIG. 6 is a drawing of the contoured laminated slate in its completed form.

### DETAILED DESCRIPTION OF THE INVENTION

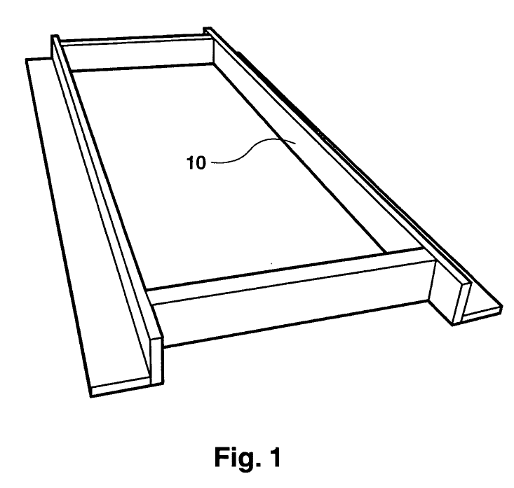

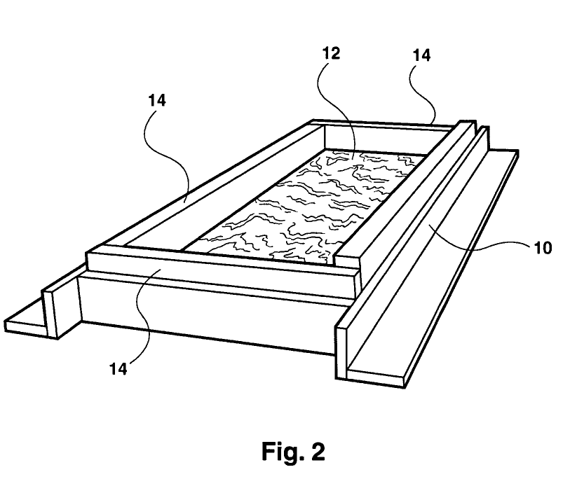

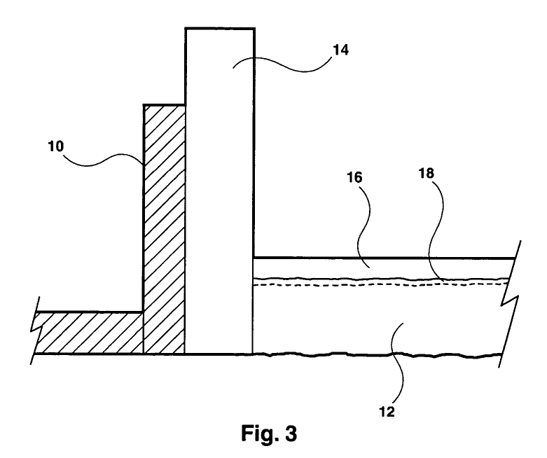

Referring to the drawings, FIG. 1 shows the basic rectangular form 10 to create the precursor slate laminate according to the present invention. For the embodiments shown, the form is of wooden construction. A slate sheet 12 having the desired dimensions is placed in the form, or conversely the form is placed over the cut rectangular sheet of slate. The form has sufficient spacing from the slate on all four edges to allow placement of resilient dams 14 between the form and slate as shown in FIG. 2. For the embodiments shown, the resilient dams are sheets of 1 ½ inch rigid foam. For the embodiment shown, the dams are fabricated from laminated polyethelyne foam. The slate laminate precursor is formed by pouring a liquid resin mixture over the slate, covering the slate to the edges interfaced by the dams with a thickness of approximately ¼ inch. FIG. 3 shows the laminated slate precursor comprising the slate sheet 12 and resin layer 16 in place in the form with the foam dams. The cleaved veneer layer 18, as will be described in greater detail subsequently, is shown in exaggerated scale for clarity.

For an exemplary embodiment of the invention, the liquid resin is a two part polyether polyol/diisocyanate available from Hydroseal Polymers, Inc. of Riverside, Calif. as product HC 650. The resin is mixed in equal parts by weight with added colorant to provide a compatible matching color for the slate. Black iron oxide pigment available as product no. BK50990 from Elements Pigment has been demonstrated to provide good results in color matching without degradation of the resin. The resin is allowed to cure on the slate for approximately 15 minutes until the resin begins to solidify but remains malleable. The foam dams are removed and the rectangular form is lifted from the slate laminate precursor. A flat sharpened metal tool is employed to cleave the slate creating a veneer of the slate adhered to the resin as a precursor for the contoured laminated slate product. For the currently employed embodiment of the method, the tool is employed beginning at one corner of the slate sheet approximately 1/16 inch below the resin line. The 1/16 inch slate layer is cleaved from the slate sheet by working the cleaving tool back and forth in jabbing strokes between the slate sheet and slate/resin veneer until the laminated slate precursor is free from the host slate sheet.

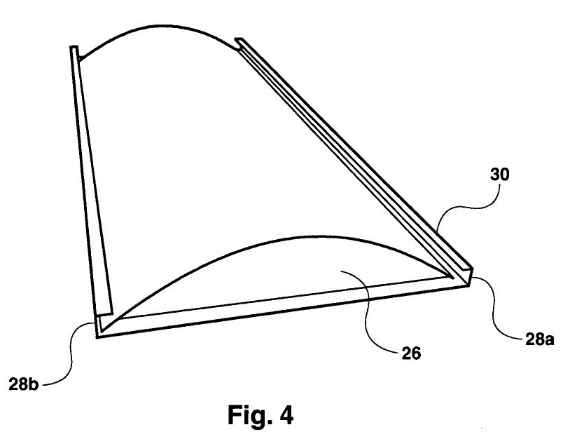

The laminated slate precursor is transferred promptly after cleaving to a contour mold for shaping. An exemplary wave mold 20 is shown in FIG. 4. This mold has multiple curves forming waves. The slate laminate precursor is placed with the resin layer against the mold surface. With various resins or resin consistency, a mold release agent is employed to avoid adherence of the resin to the mold surface. Pressure is applied to the slate laminate precursor to conform to the surface of the mold. Sandbags are placed over the surface of the slate laminate precursor to assure that contact is maintained between the mold and precursor during curing of the resin. Sand bags provide an evenly distributed weight applied to the entire precursor. Alternatively, a water bladder or vacuum bagging and processing is employed during curing. The resin on the slate laminate precursor is allowed to cure completely; approximately 2 hours for the resin employed in the embodiment as described. A stop 22 is provided to position a top edge of the laminate precursor on the mold and to prevent slippage during pressing and cure. Similarly, side stops 24a and 24b align the precursor with the mold and secure the precursor during pressing and cure.

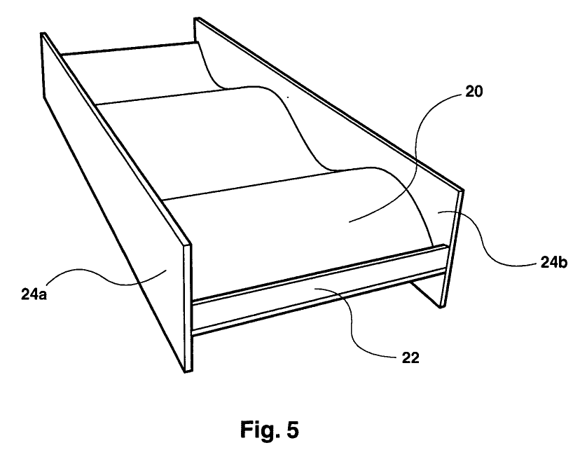

An alternative shaping mold 26 is shown in FIG. 5 which provides a longitudinal bend in the rectangular slate laminate precursor. This mold has a single arc curve. Like the wave mold, the single curvature mold provides stops 28a and 28b to engage the side edges of the laminate precursor during pressing and cure. The stops include a cap 30 extending perpendicular to the side of the stop to prevent slippage of the precursor over the edge of the stop during initial bending of the precursor onto the mold. A cap block 32 is placed between the laminate precursor and the cap to urge the edges of the laminate precursor onto the mold surface.

The use of alternative molds allows the laminated slate to be shaped for various desired artistic or functional shapes. The molds shown in FIGS. 4 and 5 provide contoured laminated slate for use in decorative fountains. Comparable molds in alternate scale can be employed to create single or double curvatures (S-curves) for shaping of the slate laminate for use as roofing tiles or other functional architectural elements.

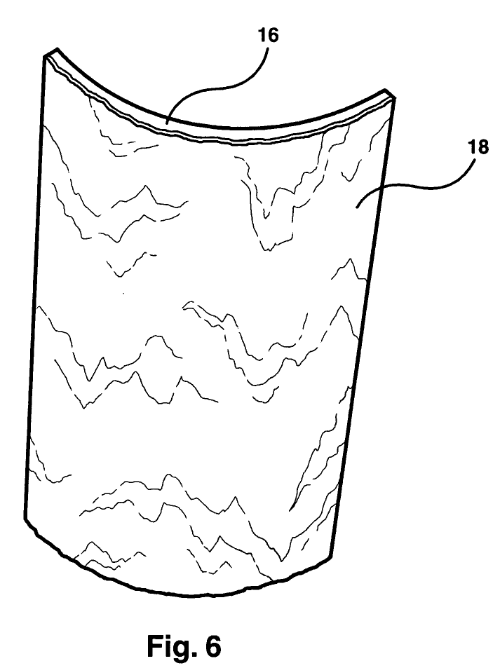

After curing, the completed contoured laminated slate product is lifted from the mold. Finishing processes including trimming or sanding of the resin/slate edges to achieve a desired appearance are applied to the product. FIG. 6 shows the completed contoured laminated slate for a single curve application.

With only a 1/16 inch thickness of slate veneer, the laminated slate is extremely light weight in comparison to a similarly sized piece of regular slate sheet. The resin provides structural support for the thin slate veneer reducing the potential for cracking. Fiber or glass reinforced resins for additional strength are employed in alternative embodiments. The laminated slate created using the inventive process is contoured providing a pleasing aesthetic effect unlike anything obtainable with regular sheet slate. Further, the contour provides additional rigidity in the laminated slate produced according to the process of the present invention as opposed to a flat laminated slate veneer.

Having now described the invention in detail as required by the patent statutes, those skilled in the art will recognize modifications and substitutions to the specific embodiments disclosed herein. Such modifications are within the scope and intent of the present invention as defined in the following claims.

1. A method for producing contoured laminated slate comprising the steps of:
cutting a sheet of slate to a desired dimension;
placing a form around the edges of the slate sheet;
inserting resilient dams intermediate the slate sheet and the form;
pouring a resin layer over the slate sheet to form a laminated slate precursor;
allowing the resin to partially cure;
removing the resilient dams and form;
cleaving a slate veneer which is adhered to the resin from the slate sheet;
placing the laminated slate precursor onto a contoured mold;
pressing the laminated slate precursor to the mold surface;
allowing the resin to completely cure; and,
removing the contoured laminated slate from the mold.

2. A method for producing contoured laminated slate as defined in claim 1 wherein the resin layer is poured to a depth of about ¼ inch.

3. A method for producing contoured laminated slate as defined in claim 1 wherein the slate veneer cleaved from the slate sheet is about 1/16 inch in thickness.

4. A method for producing contoured laminated slate as defined in claim 2 wherein the resin comprises a two part polyether polyol/diisocyanate and additionally comprising the step prior to pouring of mixing in equal parts by weight polyether polyol and diisocyanate.

5. A method for producing contoured laminated slate as defined in claim 4 further comprising during the step of mixing, the step of adding colorant compatible with the slate color.

6. A method for producing contoured laminated slate as defined in claim 1 wherein the mold has a waveshape comprising multiple curves.

7. A method for producing contoured laminated slate as defined in claim 1 wherein the mold has a single arc curve.

8. A method for producing contoured laminated slate as defined in claim 1 further comprising the step of trimming the laminated slate edges.

9. A method for producing contoured laminated slate as defined in claim 1 wherein the step of pressing includes placing sand bags on the surface of the laminated slate precursor.

10. A method for producing contoured laminated slate as defined in claim 1 wherein the resilient dams are Styrofoam sheet.

11. A contoured laminated slate having a slate veneer backed by a cured resin.

12. A contoured laminated slate as defined in claim 11 wherein the slate veneer is about 1/16 inch in thickness.

13. A contoured laminated slate as defined in claim 11 wherein the cured resin is about ¼ inch in thickness.

14. A contoured laminate slate as defined in claim 11 wherein the contour is created by curing the resin affixed to the slate veneer on a curved mold.

15. A contoured laminate slate as defined in claim 14 wherein the slate veneer is cleaved from a slate sheet with the resin partially cured prior to placement on the curved mold.

16. A contoured laminate slate as defined in claim 11 wherein the contour has a single curve.

17. A contoured laminate slate as defined in claim 11 wherein the contour has multiple curves.

18. A contoured laminate slate as defined in claim 11 wherein the resin is two part polyether polyol/diisocyanate.

19. A contoured laminated slate with multiple curves having a slate veneer of about 1/16 inch backed by a cured two part polyether polyol/diisocyanate resin with a thickness of about ¼ inch having colorant to match the slate, the contour created by curing the resin affixed to the slate veneer on a curved mold and the slate veneer is cleaved from a slate sheet with the resin partially cured prior to placement on the curved mold.
